(19) United States
(12) Patent Application Publication
(10) Pub. No.: US 2010/0026819 A1
(43) Pub. Date: Feb. 4, 2010

(54) METHOD AND APPARATUS FOR COMPENSATING FOR MOTION OF AN AUTOFOCUS AREA, AND AUTOFOCUSING METHOD AND APPARATUS USING THE SAME

(75) Inventor: Sung-shik Koh, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/508,731

(22) Filed: Jul. 24, 2009

(30) Foreign Application Priority Data
Jul. 30, 2008 (KR) 10-2008-0074720

(51) Int. Cl. H04N 5/228

(52) U.S. Cl. 348/208.4; 348/E05.031

(57) ABSTRACT

Provided is a method of compensating for a motion of an autofocus (AF) area, the method includes: comparing AF areas of a previous frame and a current frame; determining whether the AF area of the current frame moves by determining whether the AF areas of the previous frame and the current frame are identical to each other; and compensating for motion of the AF area of the current frame according to the determination.

### CROSS-REFERENCE TO RELATED PATENT APPLICATION

This application claims the benefit of Korean Patent Application No. 10-2008-0074720, filed on Jul. 30, 2008, in the Korean Intellectual Property Office, the disclosure of which is incorporated herein in its entirety by reference.

### BACKGROUND OF THE INVENTION

1. Field of the Invention

The present invention relates to autofocus (AF), and more particularly, to a method and apparatus for compensating for motion of an autofocus area caused by a handshake generated during an AF operation.

2. Description of the Related Art

Autofocus (AF) is a feature of some optical systems (cameras) that allows them to obtain correct focus on a subject, instead of requiring the operator to adjust focus manually. Compact digital cameras usually use a through-the-lens (TTL) contrast detecting method. Compact digital cameras do not comprise an additional AF sensor but comprise either a CCD (charge coupled device) or a CMOS (complementary metal oxide semiconductor) image sensor to analyze and focus images.

Conventional AF methods of adjusting a focus of a capturing lens of digital cameras photoelectric-convert a subject image by using an image capturing apparatus such as a CCD, generate an image signal, detect a high frequency component from the image signal of a predetermined AF area of the captured image, calculate an AF valuation value that is an image contrast value, and detect an in-focus position of a lens based on the AF valuation value.

Such methods calculate the AF valuation value in each position (focal position) of a focal lens while moving the focal lens in an optical axis direction and detect a position having a maximum AF valuation value as the in-focus position.

Meanwhile, technologies for preventing handshake have been applied to all recently manufactured digital cameras and are important for capturing a subject by using a digital camera. Conventional handshake preventing technologies are divided into technologies of optically moving CCDs or lenses, and processing images when a picture is captured.

With regard to CCD shifting methods, a CCD follows a motion of an image generated by a handshake. In more detail, the CCD moves in the opposite direction to the handshake so that the image formed on the CCD can maintain its position with respect to the image. With regard to lens shifting methods having the same basic principle as CCD shifting methods, a correction lens moves and an image is corrected when the image is out of a correct position due to a camera shake. With regard to image processing methods, an image is automatically captured twice while changing an International Organization for Standardization (ISO) value. In more detail, an image (shape information of a subject) captured from a picture that does not shake at a high ISO and an image (color information of the subject) having less noise at a low ISO are combined.

Meanwhile, when a user uses a digital camera having an AF function, the user places a subject that is to be captured on a focal area, e.g., a square window, presses a shutter-release button to a half-depressed state (hereinafter, S1), and presses the shutter-release button to a fully depressed state (hereinafter, S2) for inputting a shutter-release signal used to capture a picture by exposing a capturing device to light during a finally determined period of time while determining a capturing composition of a live view screen.

However, the above three handshake preventing methods mechanically correct the handshake when S2 is generated, and thus they cannot be solutions for the handshake when S1 is generated. In more detail, if the handshake occurs by pressing S2, an AF curve is transformed by a distortion of the AF valuation value, which changes a current position of a focus lens, so that an image is not clear. Conventional handshake preventing technologies are used to correct the handshake when S2 is generated. Therefore, if the handshake continuously occurs while generating S1 and S2, the handshake is compensated during S2 while the image is not clear during S1. As a result, the position of the focus lens is distorted, causing an unclear image. Therefore, a focus is not adjusted when no handshake occurs during S2, resulting in an unclear image. That is, the handshake during S2 can be compensated provided that no handshake occurs during S1.

Furthermore, the conventional handshake preventing technologies incur large costs during manufacture, are mechanically complex and are technically limited by tuning.

### SUMMARY OF THE INVENTION

The present invention provides a method and apparatus for compensating for motion of an autofocus (AF) area caused by handshake during an AF operation.

The present invention also provides an AF method and apparatus using the method and apparatus for compensating for motion of an AF area.

According to an aspect of the present invention, there is provided a method of compensating for a motion of an autofocus (AF) area, the method comprising: comparing AF areas of a previous frame and a current frame; determining whether the AF area of the current frame moves by determining whether the AF areas of the previous frame and the current frame are identical to each other; and compensating for motion of the AF area of the current frame according to the determination.

The method may further comprise, when it is determined that the AF area of the current frame moves, calculating motion information of the AF area of the current frame, wherein the AF area of the current frame is compensated according to the calculated motion information.

Whether the AF area of the current frame moves may be determined through an image matching of the AF areas of the previous area and the current area.

The motion information of the AF area of the current frame may be calculated through the image matching of the AF areas of the previous area and the current area.

The motion information may comprise motion direction and size of the AF area of the current frame.

The image matching may be performed by using one of a motion vector, a correlation matching, a pattern matching, and a color matching.

According to another aspect of the present invention, there is provided an AF method, comprising: selecting an AF area from a live view image; determining whether an AF area of a current frame moves by comparing all frames of the live view image through an image matching of AF areas of a previous frame and a current frame, and compensating for motion of the AF area of the current frame according to the determination; extracting an edge image from the compensated AF area of the current frame with regard to all frames; summing edge information values of the extracted edge image with regard to all frames; and determining a position of a focus lens corresponding to an AF value of a frame having the maximum summed edge information value.

A user may press a shutter button to a state which instructs an AF process to be performed while the live view image is displayed.

The AF area of the current frame may be compensated according to the determination by calculating motion information of the AF area of the current frame through the image matching.

According to another aspect of the present invention, there is provided a computer readable recording medium having recorded thereon a program for executing the method of compensating for a motion of an AF area.

According to another aspect of the present invention, there is provided an apparatus for compensating for a motion of an AF area, the method comprising: an AF area comparing unit comparing AF areas of a previous frame and a current frame; a motion determining unit determining whether the AF area of the current frame moves by determining whether the AF areas of the previous frame and the current frame are identical to each other; and an AF area compensating unit compensating for motion of the AF area of the current frame according to the determination.

The apparatus may further comprise: a motion calculating unit, when it is determined that the AF area of the current frame moves, calculating motion information of the AF area of the current frame, wherein the AF area compensating unit receives motion information from the motion calculating unit and compensates for the AF area of the current frame.

The motion determining unit may determine whether the AF area of the current frame moves through an image matching of the AF areas of the previous area and the current area.

The motion calculating unit may calculate motion information of the AF area of the current frame through the image matching.

The motion determining unit or the motion calculating unit may perform the image matching by using one of a motion vector, a correlation matching, a pattern matching, and a color matching.

The motion information may comprise motion direction and size of the AF area of the current frame.

According to another aspect of the present invention, there is provided an AF apparatus, comprising: an AF area selecting unit selecting an AF area from a live view image; an AF area motion compensating unit determining whether an AF area of a current frame moves by comparing all frames of the live view image through an image matching of AF areas of a previous frame and a current frame, and compensating for motion of the AF area of the current frame according to the determination; an edge extracting unit extracting an edge image from the compensated AF area of the current frame with regard to all frames; a summing unit summing edge information values of the extracted edge image with regard to all frames; and an AF value determining unit determining a position of a focus lens corresponding to an AF value of a frame having a maximum summed edge information value.

A user may press a shutter button to a state which instructs an AF process to be performed while the live view image is displayed.

The AF area motion compensating unit may calculate motion information of the AF area of the current frame through the image matching and compensates for the AF area of the current frame according to the calculated motion information.

According to another aspect of the present invention, there is provided a digital photographing apparatus comprising the AF apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional autofocus (AF) apparatus;

FIGS. 2A and 2B are diagrams for explaining variations of AF values when a handshake occurs during a conventional AF operation;

FIG. 3 is a schematic block diagram of an AF apparatus according to an embodiment of the present invention;

FIGS. 4A and 4B are diagrams for explaining motion caused by handshake during an AF operation according to an embodiment of the present invention; and

FIG. 5 is a flowchart of an AF method according to an embodiment of the present invention.

### DETAILED DESCRIPTION OF THE INVENTION

Hereinafter, the present invention will be described more fully with reference to the accompanying drawings, in which exemplary embodiments of the invention are shown. While describing the present invention, detailed descriptions about related well known functions or configurations that may blur the points of the present invention are omitted.

All terms (including technical and scientific terms) used herein, such as those defined in commonly used dictionaries, should be interpreted as having a meaning that is consistent with their meaning in the context of the relevant art and will not be interpreted in an idealized or overly formal sense unless expressly so defined herein.

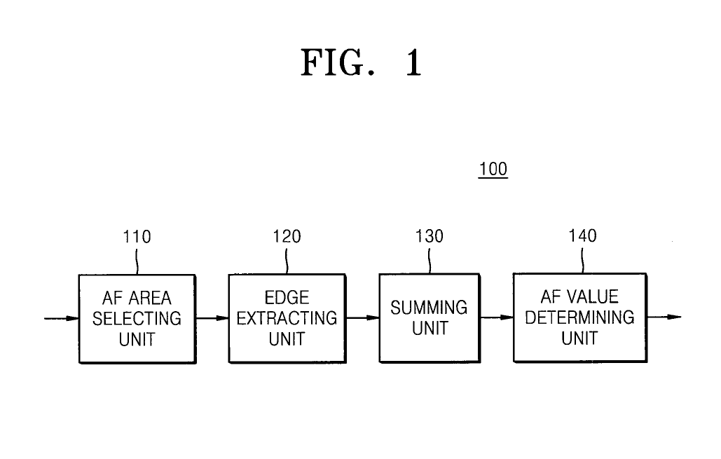

FIG. 1 is a block diagram of a conventional autofocus (AF) apparatus 100. Referring to FIG. 1, the AF apparatus 100 comprises an AF area selecting unit 110, an edge extracting unit 120, a summing unit 130, and an AF value determining unit 140.

The AF apparatus 100 extracts a high frequency component value of each of image signals, obtains an AF value by integrating an absolute value of the high frequency component value of each image signal, and determines a position of a focus lens having a maximum AF valuation value.

The AF area selecting unit 110 selects an AF area from a live view image of a digital camera. A user places a square window on a subject that is to be photographed and fixes the AF area.

The edge extracting unit 120 extracts an edge image from each image signal by passing each image signal through a high pass filter (HPF) with regard to all respective frames forming the live view image. All frames are image frames forming the live view image. For example, 10 frames may be used to form the live view image. The edge extracting unit 120 extracts a high frequency component of each image signal of all frames by passing each image signal through the HPF. The extraction of the high frequency component of each of a series of image signals is performed since focusing of an image requires a precise sensitivity and thus it needs a precise value for the high frequency component.

The summing unit 130 sums amounts of edge information about the edge image of each image signal output by the edge extracting unit 120. In more detail, the summing unit 130 sums edge information by integrating values forming the high frequency component of each image signal.

The AF value determining unit 140 determines the position of the focus lens corresponding to an AF value of a frame having the maximum amount of edge information output by the summing unit 130. In more detail, the AF value determining unit 140 performs an AF process by discovering the AF value having the maximum amount of edge information from all frames, determining the position of the focus lens at the discovered AF value as an in-focus point, and moving the focus lens to the in-focus point.

The AF process for determining the position of the focus lens moves the focus lens step by step, obtains the AF value, and places the focus lens in the position having the maximum AF value. The high frequency component of the image signal is a maximum at the in-focus point, so that the focus lens is placed at the position having the maximum AF value, thereby placing the focus lens at the most in-focus point.

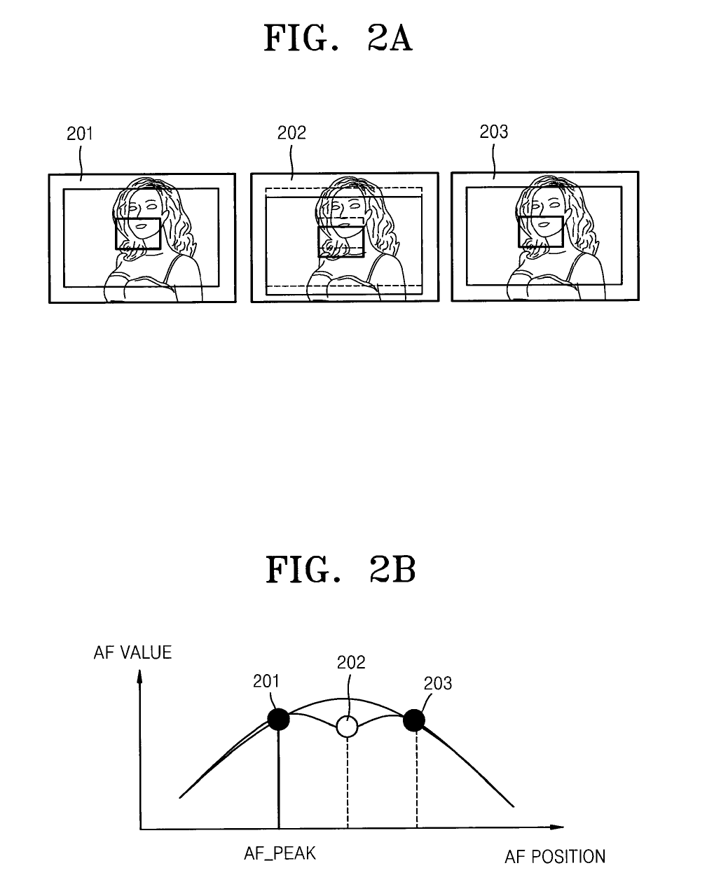

FIGS. 2A and 2B are diagrams for explaining variations of AF values when handshake occurs during a conventional AF operation. Referring to FIG. 2A, each of three image frames 201, 202, and 203 is a part of frames forming a live view image. A focal area of the image frames 201, 202, and 203 is a square window area in the region of a subject's mouth. The focal area of the second frame 202 comes down due to the pressing of the shutter button to a half-depressed state by a user or for another reason, for example, a user's handshake in order to fix the focal area.

Referring to FIG. 2B, a graph shows a result obtained by performing the AF process described with reference to FIG. 1 with regard to the frames.

A horizontal axis indicates AF positions, i.e., positions of a focus lens. A vertical axis indicates AF values. Reference numeral 201 is an AF value of the focal area of the first frame 201. As described with reference to FIG. 1, the AF value of the first frame 201 is obtained by extracting a high frequency component level of an image signal and integrating an absolute value of the high frequency component level of the image signal. AF values of the second and third frames 202 and 203 are obtained in the same manner as described above. The AF values of all the frames 201, 202, and 203 form a curve, which represents an AF curve.

The AF value of the second frame 202 is decreased due to the motion of the focal area. The AF apparatus 100 calculates the AF values 201 through 203 in the AF curve. The first frame 201 is evaluated as having the maximum AF value and the AF position corresponding to the maximum AF value, i.e., the position of the focus lens since the AF value of the second frame 202 is distorted by the handshake or the motion. Therefore, the result obtained by performing the AF process is distorted and thus a photographed image is not clearly focused.

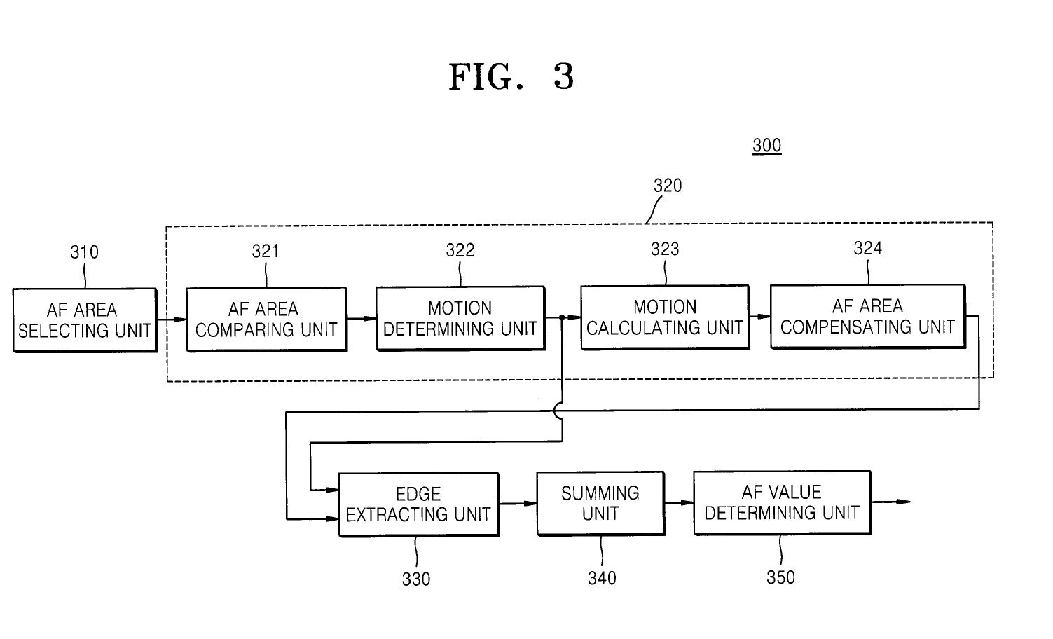

FIG. 3 is a schematic block diagram of an AF apparatus 300 according to an embodiment of the present invention. Referring to FIG. 3, the AF apparatus 300 comprises an AF area selecting unit 310, an AF area motion compensating unit 320, an edge extracting unit 330, a summing unit 340, and an AF value determining unit 350. The AF area motion compensating unit 320 comprises an AF area comparing unit 321, a motion determining unit 322, a motion calculating unit 323, and an AF area compensating unit 324.

The AF apparatus 300 of the present embodiment comprising the AF area motion compensating unit 320 differs from the conventional AF apparatus 100 shown in FIG. 1. The AF area motion compensating unit 320 compares all frames of a live view image through an image matching of an AF area of a previous frame and a current frame, for example, an n-1^{st} frame and an n^{th} frame. The AF area motion compensating unit 320 determines whether the AF area of the current frame moves based on the comparison result, and, if the AF area moves, compensates for the motion of the AF area of the current frame, thereby preventing distortion of an AF value caused by handshake during an AF process.

The AF area selecting unit 310 selects the AF area from the live view image.

The AF area motion compensating unit 320 compares all frames of the live view image output by the AF area selecting unit 310 through the image matching of the AF area of a previous frame and a current frame, determines whether the AF area of the current frame moves based on the comparison result, and, if the AF area moves, compensates for the motion of the AF area of the current frame. The image matching is performed by using s a motion vector, a correlation matching, a pattern matching, a color matching, etc.

The motion vector expresses a motion amount between a previous screen and a current screen in terms of a direction and size. The color matching is performed by measuring a similarity between color distributions. As an example of the color matching, a color histogram intersection method calculates a similarity of the color distribution between images.

The pattern matching stores a pattern of an image signal of a previous frame, and determines whether the stored pattern and an image pattern of the current frame are similar to each other. For example, the pattern matching extracts the feature of the previous frame, and searches for the feature similar to the extracted feature from the current frame.

In the present exemplary embodiment, although the motion vector, the correlation matching, the pattern matching, and the color matching are used as the image matching method, the present invention is not limited thereto. It will be understood by one of ordinary skill in the art that other image matching methods, in particular, of comparing previous and current image frames and confirming whether images are identical to each other, may be used.

In more detail, the AF area motion compensating unit 320 comprises an AF area comparing unit 321, a motion determining unit 322, a motion calculating unit 323, and an AF area compensating unit 324.

The AF area comparing unit 321 compares AF areas of the previous and current frames, that is, AF areas of an n-1^{st} frame and an n^{th} frame.

The motion determining unit 322 determines whether the AF areas of the previous and current frames are identical to each other by comparing the AF areas of the previous and current frames. One of the image matching methods may be used to determine whether the AF areas of the previous and current frames are identical to each other. Therefore, the motion determining unit 322 determines whether the AF areas move due to handshake during an S1, i.e., until the user fully presses a shutter release button on a live view screen. The above method is performed with regard to all frames forming the live view image. Alternatively, when the motion determining unit 322 determines that the AF areas do not move, the motion determining unit 322 provides the edge extracting unit 330 with the AF area of the current frame.

When the motion determining unit 322 determines that the AF area of the current frame moves, i.e., that the AF areas of the previous frame and the current frame are not identical to each other, the motion calculating unit 323 calculates motion information of the AF areas of the current frame. The motion information includes motion direction and size of the AF areas of the current frame. The motion size may indicate how many pixels the AF areas of the current frame move. The motion information may be obtained by performing the image matching process. For example, with regard to the motion vector, if a motion vector of the previous frame is estimated, the motion information may be calculated by obtaining direction and size components of the estimated vector.

In the present exemplary embodiment, although the motion determining unit 322 and the motion calculating unit 323 are separated from each other, the determination of whether the AF area moves and calculation of the motion of the AF area can be simultaneously performed.

The AF area compensating unit 324 receives the motion information from the motion calculating unit 323 and compensates for the AF area of the current frame according to the motion information. For example, if the motion information is 3 pixels in a 6 o'clock direction, the AF area compensating unit 324 compensates for the AF area of the current frame by moving the AF area of the current frame by 3 pixels in a 12 o'clock direction.

The edge extracting unit 330 extracts an edge image of each frame from the compensated AF area according to the compensation result of the AF area motion compensating unit 320. When the AF area does not move, the given AF area is maintained, and the edge image can be extracted from the given AF area.

The summing unit 340 sums an edge information value of each edge image extracted from the edge extracting unit 330.

The AF value determining unit 350 determines a position of a focus lens corresponding to an AF value of a frame having the maximum summed edge information value output by the summing unit 130. In the present exemplary embodiment, although the AF value determining unit 350 determines the position of the focus lens according to the maximum AF value, the AF value determining unit 350 determines the maximum AF value and receives the determined maximum AF value, and enables a controller (not shown) to control the position of the focus lens through an optical driving controller.

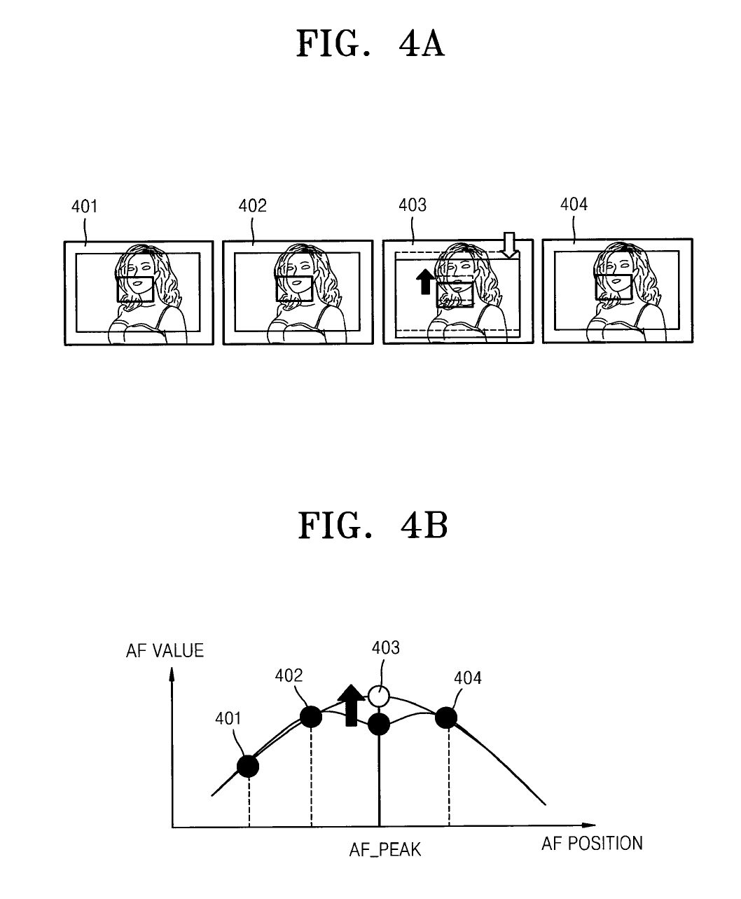

FIGS. 4A and 4B are diagrams for explaining a motion caused by a handshake during an AF operation according to an embodiment of the present invention.

Referring to FIG. 4A, each of four frames 401, 402, 403, and 404 is a part of frames forming a live view image. A focal area of the image frames 401, 402, 403, and 404 is a square window area in the region of a subject's mouth. The focal area of the third frame 403 comes down due to the pressing of the shutter button to a half depressed state by a user or for another reason, for example, a user's handshake in order to fix the focal area.

Referring to FIG. 4B, a graph shows a result obtained by performing the AF process described with reference to FIG. 3 with regard to the third frame 403.

A horizontal axis indicates AF positions, i.e., positions of a focus lens. A vertical axis indicates AF values.

In the present exemplary embodiment, AF areas of the first frame 401 and the second frame 402 are shown to not move by comparing the AF areas. Thereafter, AF areas of the second frame 402 and the third frame 403 are compared. A motion occurs in the third frame 403 by the handshake and the AF area comes down. Therefore, the AF areas of the second frame 402 and the third frame 403 are determined to not be identical to each other, and thus an AF area motion compensation process is performed. An image matching of the second frame 420 and the third frame 403 is used to calculate motion information, thereby compensating for a position of the AF area according to the motion information.

If the AF area motion compensation process is completely performed with regard to all frames, an AF value calculation process is performed.

Reference numeral 401 is an AF value of the focal area of the first frame 401. As described with reference to FIG. 1, the AF value of the first frame 401 is obtained by extracting a high frequency component level of an image signal and integrating an absolute value of the high frequency component level of the image signal. An AF value of the second frame 402, an AF value of a third frame 403 with regards to the compensated AF area, and an AF value of the fourth frame 404 are obtained in the same manner as described above. With regard to the AF values of all the frames 401, 402, 403, and 404 as shown, a motion of the AF area of the third frame 403 is compensated, thereby obtaining a desirable AF value. Therefore, the AF value of the third frame 403 is a maximum so that an AF position corresponding to the AF value 403 of the third frame, i.e. a position of the focus lens, is focused. If the motion of the AF area is not compensated, the AF value 402 of the second frame is determined to be a maximum, and thus an AF position of the AF value 402 of the second frame is determined to be an in-focus point, resulting in a distortion of adjusting the position of the focus lens.

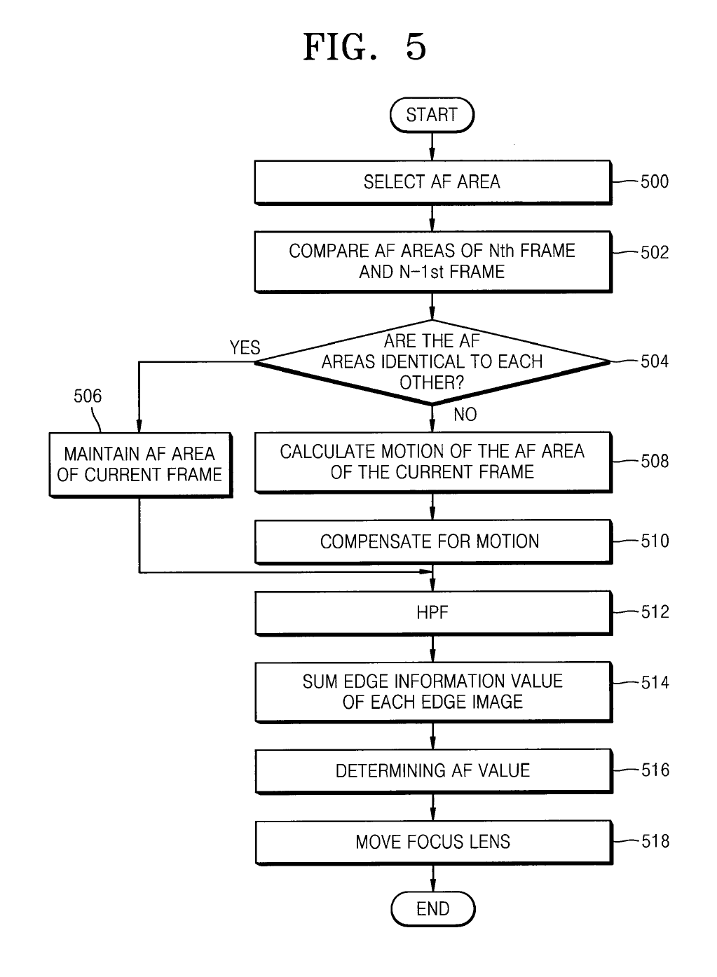

FIG. 5 is a flowchart of an AF method according to an embodiment of the present invention. Referring to FIG. 5, in operation 500, an AF area is selected. The AF area may be manually selected by a user. In operation 502, AF areas of an n-1^{st} frame and an n^{th} frame are compared. In operation 504, it is determined whether the AF areas of the n-1^{st} frame and the n^{th} frame are identical to each other through an image matching between previous and current frames. When the AF areas are determined to be identical to each other, in operation 506, the AF area of the current frame is maintained. When the AF areas are determined not to be identical to each other, in operation 508, a motion of the AF area of the current frame is calculated. In operation 510, a position of the AF area of the current frame is compensated according to the calculated motion.

In operation 512, an edge image is extracted from each of image signals of all frames by passing image signals through an HPF. The extraction of the edge image, i.e., a high frequency component, is performed since a focused image has a precise sensitivity and thus it needs the high frequency component.

In operation 514, edge information values of each edge image are summed. In more detail, the edge information values are summed by integrating high frequency component values of image signals.

In operation 516, an AF value of a frame having a maximum summed edge information value is determined. In more detail, the AF value of the frame having the maximum summed edge information value is discovered from all frames.

In operation 518, a position of a focus lens corresponding to the AF value of the frame having the maximum summed edge information value is determined as an in-focus point, and the focus lens is moved to the in-focus point, thereby completely performing an AF process.

The AF apparatus 300 according to the present invention can be applied to a digital photographing apparatus. In this case, the AF apparatus 300 can be implemented as a specific functional module within a DSP chip of the digital photographing apparatus or software, controls an optical driving controller under the control of the DSP, and controls a position of the focus lens, thereby focusing the AF apparatus 300.

When a user presses a shutter button (into a half-depressed state) used to perform an AF process while a live view image of the digital photographing apparatus is displayed, the method of compensating for motion of an AF area of the present invention can be applied.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While this invention has been particularly shown and described with reference to preferred embodiments thereof, it will be understood by those of ordinary skill in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of compensating for a motion of an autofocus (AF) area, the method comprising:
comparing AF areas of a previous frame and a current frame;
determining whether the AF area of the current frame moves by determining whether the AF areas of the previous frame and the current frame are identical to each other; and
compensating for motion of the AF area of the current frame according to the determination.

2. The method of claim 1, further comprising, when it is determined that the AF area of the current frame moves, calculating motion information of the AF area of the current frame,
wherein the AF area of the current frame is compensated according to the calculated motion information.

3. The method of claim 2, wherein whether the AF area of the current frame moves is determined through an image matching of the AF areas of the previous area and the current area.

4. The method of claim 3, wherein the motion information of the AF area of the current frame is calculated through the image matching of the AF areas of the previous area and the current area.

5. The method of claim 2, wherein the motion information comprises motion direction and size of the AF area of the current frame.

6. The method of claim 3, wherein the image matching is performed by using one of a motion vector, a correlation matching, a pattern matching, and a color matching.

7. An AF method, comprising:
selecting an AF area from a live view image;
determining whether an AF area of a current frame moves by comparing all frames of the live view image through an image matching of AF areas of a previous frame and a current frame, and compensating for motion of the AF area of the current frame according to the determination;
extracting an edge image from the compensated AF area of the current frame with regard to all frames;
summing edge information values of the extracted edge image with regard to all frames; and
determining a position of a focus lens corresponding to an AF value of a frame having the maximum summed edge information value.

8. The method of claim 7, wherein a user presses a shutter button to a state which instructs an AF process to be performed while the live view image is displayed.

9. The method of claim 7, wherein the AF area of the current frame is compensated according to the determination by calculating motion information of the AF area of the current frame through the image matching.

10. A computer readable recording medium having recorded thereon a program for executing the method of claim 1.

11. An apparatus for compensating for a motion of an AF area, the apparatus comprising:
an AF area comparing unit for comparing AF areas of a previous frame and a current frame;
a motion determining unit for determining whether the AF area of the current frame moves by determining whether the AF areas of the previous frame and the current frame are identical to each other; and
an AF area compensating unit for compensating for motion of the AF area of the current frame according to the determination.

12. The apparatus of claim 11, further comprising: a motion calculating unit, when it is determined that the AF area of the current frame moves, for calculating motion information of the AF area of the current frame,
wherein the AF area compensating unit receives motion information from the motion calculating unit and compensates for the AF area of the current frame.

13. The apparatus of claim 12, wherein the motion determining unit determines whether the AF area of the current frame moves through an image matching of the AF areas of the previous area and the current area.

14. The apparatus of claim 13, wherein the motion calculating unit calculates motion information of the AF area of the current frame through the image matching.

15. The apparatus of claim 14, wherein the motion determining unit or the motion calculating unit performs the image matching by using one of a motion vector, a correlation matching, a pattern matching, and a color matching.

16. The apparatus of claim 14, wherein the motion information comprises motion direction and size of the AF area of the current frame.

17. An AF apparatus, comprising:
an AF area selecting unit for selecting an AF area from a live view image;
an AF area motion compensating unit determining whether an AF area of a current frame moves by comparing all frames of the live view image through an image matching of AF areas of a previous frame and a current frame, and compensating for motion of the AF area of the current frame according to the determination;
an edge extracting unit for extracting an edge image from the compensated AF area of the current frame with regard to all frames;
a summing unit for summing edge information values of the extracted edge image with regard to all frames; and
an AF value determining unit for determining a position of a focus lens corresponding to an AF value of a frame having a maximum summed edge information value.

18. The apparatus of claim 17, wherein a user presses a shutter button to a state which instructs an AF process to be performed while the live view image is displayed.

19. The apparatus of claim 7, wherein the AF area motion compensating unit calculates motion information of the AF area of the current frame through the image matching and compensates for the AF area of the current frame according to the calculated motion information.

20. A digital photographing apparatus comprising the AF apparatus of claim 17.
